(19) United States
(12) Patent Application Publication
(10) Pub. No.: US 2019/0063799 A1
(43) Pub. Date: Feb. 28, 2019

(54) COOLING SYSTEMS AND PROCESSES

(71) Applicant: Rickey S. Lutterbach, Long Beach, IN (US)

(72) Inventor: Rickey S. Lutterbach, Long Beach, IN (US)

(21) Appl. No.: 16/111,574

(22) Filed: Aug. 24, 2018

Related U.S. Application Data
(60) Provisional application No. 62/549,485, filed on Aug. 24, 2017.

(51) Int. Cl. F25B 25/00; F24F 5/00; B01D 3/14; B01D 5/00; B01D 1/00

(52) U.S. Cl. CPC F25B 25/005; F24F 5/0042; F25B 21/02; B01D 5/0051; B01D 1/0082; B01D 3/143

(57) ABSTRACT

Systems and processes capable of cooling gases, liquids, and solids without requiring the use of conventional refrigerants. Such a system or process for cooling a process fluid involves a passive cooling device that receives the process fluid from a reservoir and cools the process fluid by thermal conduction to a heat sink, an active cooling device that receives the process fluid from the passive cooling device and cools the process fluid with a coolant cooled by at least one thermoelectric device, and a housing that encloses the passive and active cooling devices and serves as the heat sink for the passive cooling device.

### CROSS REFERENCE TO RELATED APPLICATIONS

This application claims the benefit of U.S. Provisional Application No. 62/549,485, filed Aug. 24, 2017, the contents of which are incorporated herein by reference.

### BACKGROUND OF THE INVENTION

The present invention generally relates to systems and processes adapted to cool gases, liquids, and solids. The invention particularly relates to systems and processes capable of cooling gases, liquids, and solids without requiring the use of conventional refrigerants.

U.S. patent application Ser. No. 15/603,822, the contents of which are incorporated herein by reference, discloses systems and processes capable of performing liquid treatments that permit reclaiming, recycling, and reusing liquids, as a nonlimiting example, reclaiming water from contaminated water or other feedstocks. The systems and processes preferably do not require large amounts of capital for construction, promote high ratios of gallons of treated feedstock to equipment footprint, and are capable of being transported and placed near the source of feedstock. The systems and processes also preferably include the ability to produce a liquid that is sufficiently purified for its intended end use while requiring relatively low amounts of energy to do so. In addition, the systems and processes offer the ability to provide purification at various selective levels as desired by an end user's requirements, rather than being limited to a fully distilled liquid end product.

The systems and processes disclosed by U.S. patent application Ser. No. 15/603,822 utilize one or more distillation vessels having condensation surfaces that require a cooling means to promote condensation of vapors. Particularly suitable cooling means would be consistent with the desire to provide a mobile system having relatively low capital construction costs and energy requirements, while also being environmentally friendly. It can be challenging for conventional cooling systems that utilize a refrigeration cycle to meet these goals, as they involve the use of a compressor to compress an appropriate refrigerant, such as a chlorofluorocarbon (CFC) known as Freon, carbon dioxide (CO₂), or another alternative refrigerant.

### BRIEF DESCRIPTION OF THE INVENTION

The present invention provides systems and processes capable of cooling gases, liquids, and solids without requiring the use of conventional refrigerants.

According to one aspect of the invention, a system for cooling a process fluid includes a passive cooling means that receives the process fluid from a reservoir and cools the process fluid by thermal conduction to a heat sink, an active cooling means that receives the process fluid from the passive cooling mean and cools the process fluid with a coolant cooled by at least one thermoelectric device, and a housing that encloses the passive and active cooling means and serves as the heat sink for the passive cooling means.

According to another aspect of the invention, a process for cooling a process fluid includes passively cooling the process fluid by receiving the process fluid from a reservoir and cooling the process fluid by thermal conduction to a heat sink, actively cooling the process fluid by receiving the process fluid after being passively cooled and cooling the process fluid with a coolant cooled by at least one thermoelectric device, and then returning the process fluid to the reservoir.

Technical aspects of the systems and processes described above preferably include the ability to cool a fluid in an efficient and economical manner without the use of conventional refrigerants such as Freon and carbon dioxide. The systems and processes are particularly suitable for use with and in the systems and processes disclosed by U.S. patent application Ser. No. 15/603,822, especially when configured to cost-effectively promote high volumes of treated feedstock.

Other aspects and advantages of this invention will be further appreciated from the following detailed description.

### BRIEF DESCRIPTION OF THE DRAWINGS

FIG. 1 schematically represents a cooling system in accordance with a nonlimiting embodiment of this invention.

FIGS. 2 through 6 schematically represent separate components of the system depicted in FIG. 1.

### DETAILED DESCRIPTION OF THE INVENTION

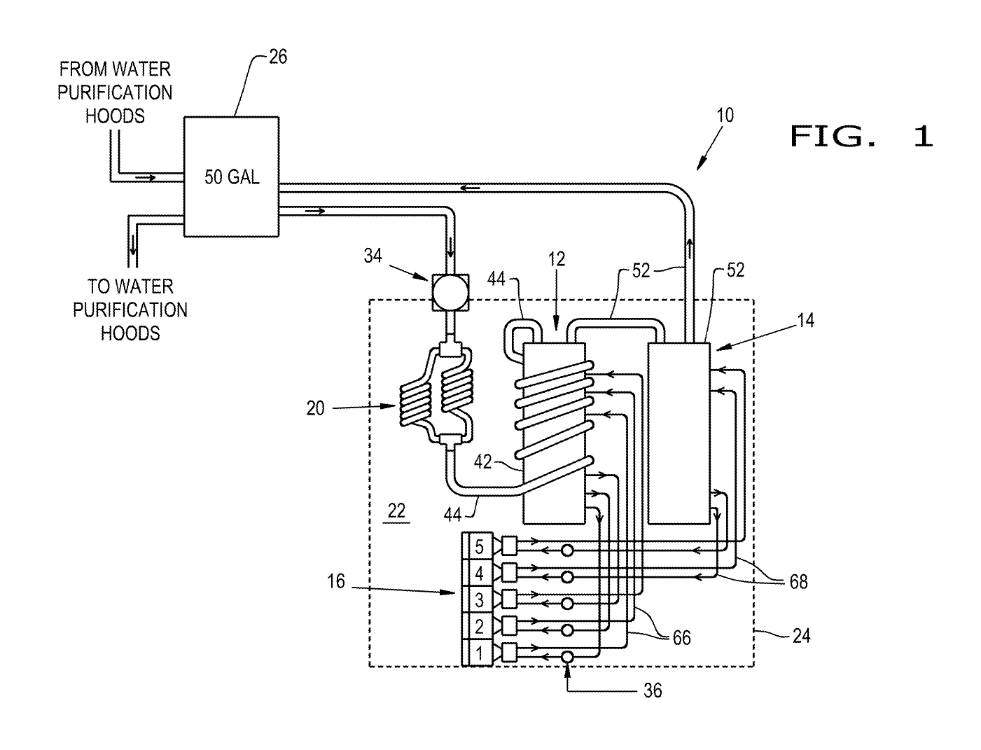

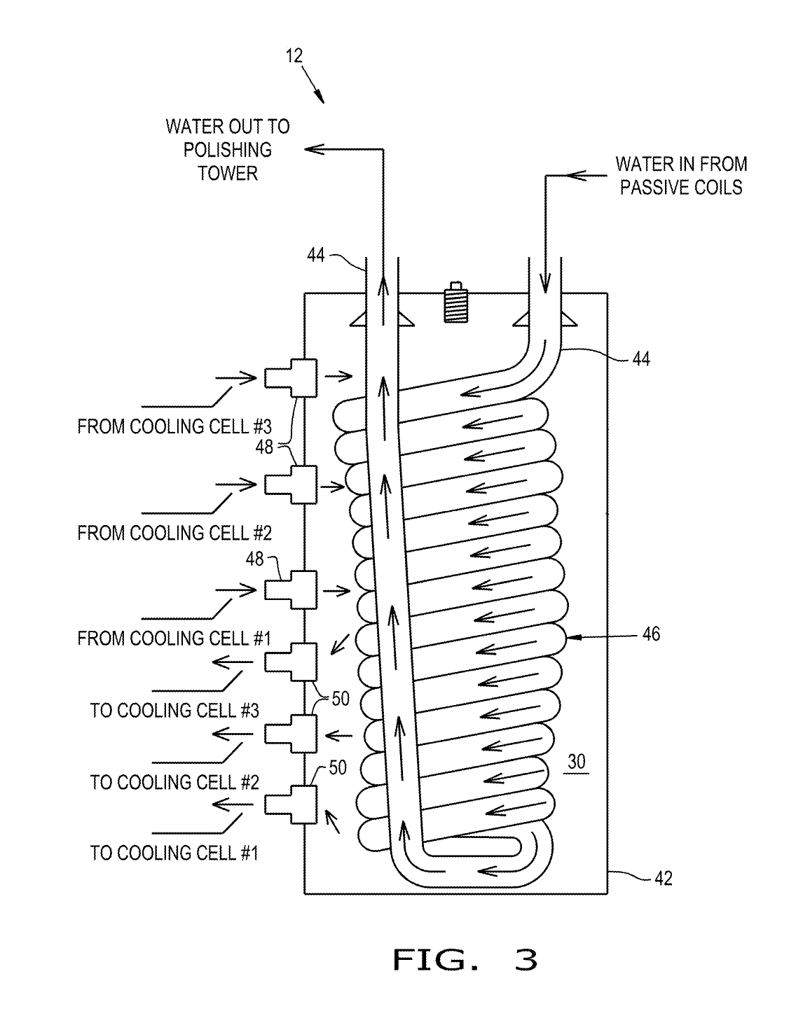

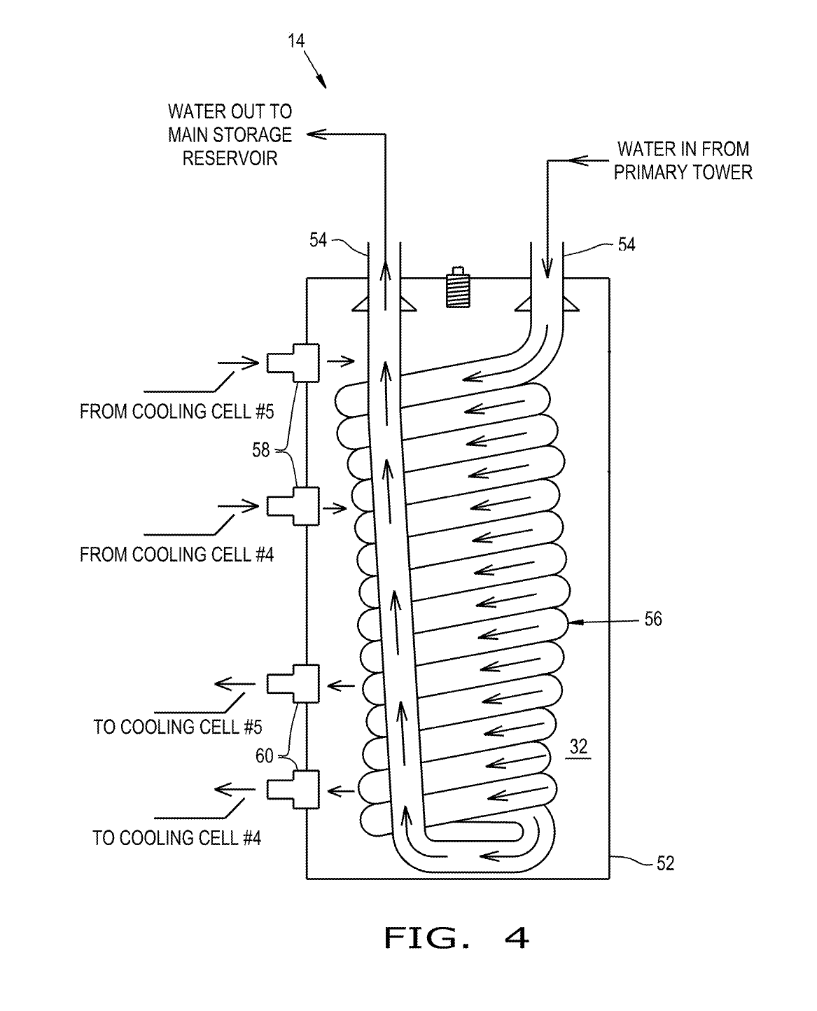

FIG. 1 represents a cooling system 10 that preferably employs both passive and active cooling techniques to reduce the temperature of a fluid. As represented in FIG. 1, the cooling system 10 contains what will be referred to herein as a “primary tower” 12 and a “polishing tower” 14. The primary and polishing towers 12 and 14 are both utilized by the system 10 to perform active cooling of a first fluid (for example, water) in a first “primary” fluid circuit by utilizing a second fluid (for example, water) that is contained in a separate “secondary” fluid circuit and continuously circulated through thermoelectric cooling cells 16. As a matter of convenience, the first and second fluids will be referred to herein as the process fluid and coolant, respectively. The coolant is circulated between the cooling cells 16 and chambers 30 and 32 (FIGS. 3 and 4) within the primary and polishing towers 12 and 14, respectively, and the cooling cells 16 reduce the temperature of the coolant before being injected at multiple locations within each of the primary and polishing chambers 30 and 32.

As also represented in FIG. 1, the cooling system 10 further contains one or more cooling coils 20 that perform passive cooling of the process fluid prior to the process fluid being routed to the primary tower 12. The primary tower 12, polishing tower 14, cooling cells 16, and cooling coils 20 are all housed within an interior chamber 22 defined by a housing 24 that serves as a heat sink for the cooling coils 20. The process fluid is drawn from a storage reservoir 26, then circulated through the cooling coils 20, primary tower 12, and polishing tower 14 within the housing 24 prior to being routed back to the reservoir 26, thus maintaining a cool process fluid within the reservoir 26.

A wide range of temperatures can be achieved and maintained for the process fluid within the reservoir 26, and appropriate temperatures will depend on the intended use of the process fluid. As a nonlimiting example, the process fluid can be utilized by the systems and processes disclosed in U.S. patent application Ser. No. 15/603,822 to cool a condensation surface of a distillation vessel to promote the condensation of vapors within the vessel. The cooling system 10 depicted in FIG. 1 is capable of operating in a mobile system desired to have relatively low capital construction costs and energy requirements, while also being environmentally friendly. Notably, the cooling system 10 does not require the use of a refrigeration cycle or compressors and refrigerants associated therewith.

It should be noted that the drawings are drawn for purposes of clarity when viewed in combination with the following description, and therefore are not necessarily to scale. Furthermore, dimensions and various parameters indicated in the drawings are for reference purposes only, and are not to be necessarily interpreted as limiting the scope of the invention. To facilitate the description provided below of the system 10 represented in the drawings, relative terms, including but not limited to, “vertical,” “horizontal,” “lateral,” “front,” “rear,” “side,” “forward,” “rearward,” “upper,” “lower,” “above,” “below,” “right,” “left,” etc., may be used in reference to a typical installation of the system 10 when used as represented in FIG. 1 but should not be necessarily interpreted as limitations to the construction, installation, operation, or use of the system 10.

Referring again to FIG. 1, the system 10 is represented as using pumps 34 and 36 as means for inducing flow of the process fluid and coolant. The pump 34 is used to pump the process fluid through the primary fluid circuit, which in the embodiment shown comprises a flow path from the reservoir 26 to the cooling coils 20, and then sequentially through the primary and polishing towers 12 and 14 before returning to the reservoir 26, and the individual pumps 36 are used to pump the coolant through the secondary fluid circuit, which in the embodiment shown comprises multiple flow paths from the cooling cells 16 to each of the primary and polishing chamber 30 and 32, and then back to the cooling cells 16. The process fluid will typically be pumped at greater volumetric rates than the coolant at each individual cooling cell 16, and therefore the pump 34 will usually have a larger capacity than each individual pump 36.

From FIGS. 1 through 4, it can be appreciated that the cooling coils 20, primary tower 12, polishing tower 14, housing 24, and conduits that transport the process fluid and coolant therebetween are preferably configured to provide large surface areas across which heat can be transferred from the process fluid to the coolant. Additionally, each of these components is preferably formed of a thermally conductive material, for example, a metal such as copper, an aluminum alloy, etc., in which case thermal contact between the components can be promoted with solder, braze, or weld joints or conductive adhesives.

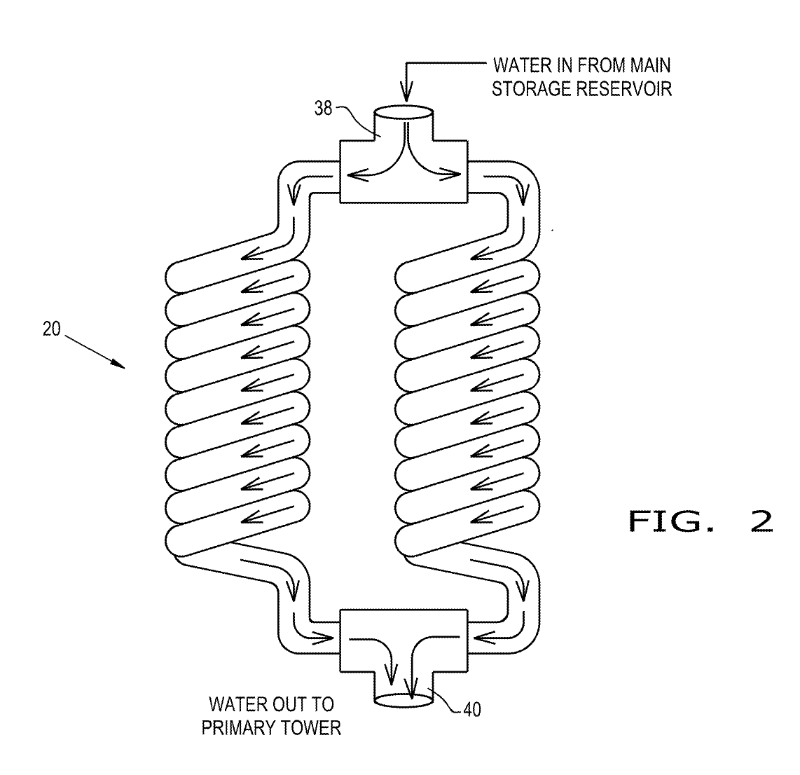

FIG. 2 depicts a more detailed view of the cooling coils 20. The cooling coils 20 serve as a passive cooling unit for the process fluid prior to the process fluid being routed to the primary tower 12. The inclusion of such a passive cooling unit upstream of the primary tower 12 is advantageous to offset input energy requirements of the cooling cells 16 used to cool the coolant within the primary and polishing towers 12 and 14, which serve as active cooling units of the system 10. As a nonlimiting example, it is believed that the cooling coils 20 (or another passive cooling unit) should achieve a temperature drop in the process fluid of at least 10° F. (about 2° C.).

In the nonlimiting example shown in the drawings, the coils 20 comprise two individual coils 20 that receive the process fluid through a Y-fitting 38 and then return the process fluid to a single flow path via a second Y-fitting 40. The coils 20 are preferably in direct or indirect physical contact with the housing (heat sink) 24 so that heat can be passively conducted from the process fluid, through the coils 20, and to the housing 24. Each individual coil 20 is formed by wrapping tubing so that each turn of the tubing is in direct physical contact with each preceding and each succeeding turn of the tubing. The individual coils 20 are shown as being physically spaced apart from each other to minimize any heat transfer between the coils 20. Because the coils 20 are cooled by the housing 24, an alternative embodiment (not shown) is to configure the coils 20 in a serpentine-like manner and solder the coils 20 against a wall of the housing 24. Another alternative is to directly incorporate the passive cooling unit as serpentine fluid passages that are within one or more walls of the housing 24. In addition or alternatively, the coils 20 could be equipped with cooling fins.

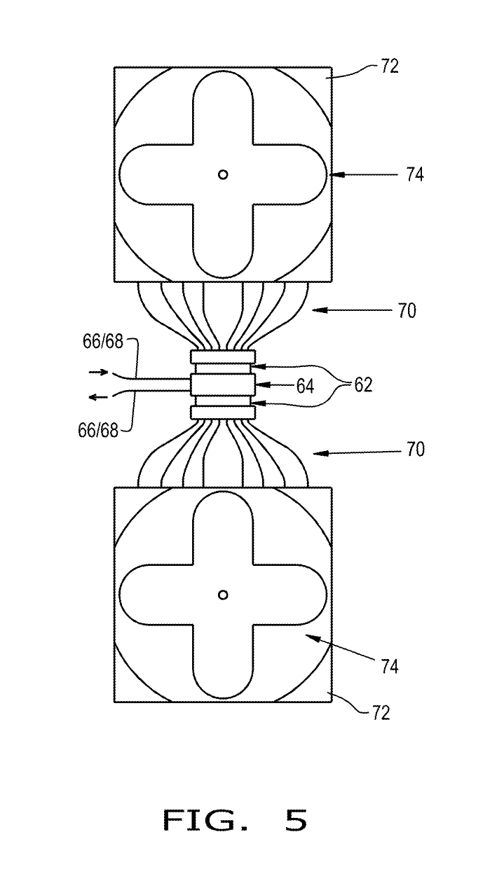

FIG. 3 depicts a more detailed view of the primary tower 12. In this nonlimiting example, the primary tower 12 comprises a tank 42 in which the primary chamber 30 is defined. Tubing 44 from the cooling coils 20 is wrapped around the exterior of the tank 42 before entering the chamber 30, where the tubing 44 defines a primary coil 46 formed by winding the tubing 44 so that each turn of the wound tubing 44 is in direct physical contact with each preceding and each succeeding turn of the tubing 44. Downstream of the coil 46, the tubing 44 is routed out of the chamber 30 before proceeding to the polishing tower 14. The chamber 30 is preferably completely filled with the coolant, such that the tubing 44 is completely immersed in the coolant. In the embodiment shown, the coolant enters the chamber 30 via three fittings 48 and exits the chamber 30 through three fittings 50 that, respectively, receive the coolant from and return the coolant to three of the cooling cells 16. The fittings 48 are preferably located above the fittings 50 so that the colder coolant received from the cooling cells 16 better intermixes with the coolant in the chamber 30. Intimate contact between the coolant and the coil 46 promotes thermal conduction from the process fluid to the coolant within the chamber 30. The temperature of the processing fluid exiting the primary tower 12 can be controlled by controlling the operation of the three cooling cells 16 (discussed below in reference to FIG. 5) delivering the coolant to the primary chamber 30.

FIG. 4 depicts a more detailed view of the polishing tower 14. In this nonlimiting example, the construction of the polishing tower 14 closely resembles that of the primary tower 12. The polishing tower 14 comprises a tank 52 in which the polishing chamber 32 is defined. Tubing 54 from the primary tower 12 enters the polishing chamber 32, where the tubing 54 defines a polishing coil 56 formed by winding the tubing 54 so that each turn of the wound tubing 54 is in direct physical contact with each preceding and each succeeding turn of the tubing 54. Downstream of the coil 56, the tubing 54 is routed out of the chamber 32 before proceeding to the reservoir 26. The chamber 32 is preferably completely filled with the coolant, such that the tubing 54 is completely immersed in the coolant. In the embodiment shown, the coolant enters the chamber 32 via two fittings 58 and exits the chamber 32 through two fittings 60 that, respectively, receive the coolant from and return the coolant to two of the cooling cells 16. The fittings 58 are preferably located above the fittings 60 so that the colder coolant received from the cooling cells 16 better intermixes with the coolant in the chamber 32. Intimate contact between the coolant and the coil 46 promotes thermal conduction from the process fluid to the coolant within the chamber 32. Aside from the number of fittings 58 and 60, the polishing tower 14 may be identical to the primary tower 12.

A benefit of the polishing tower 14 is that it can be used to control the final temperature of the processing fluid in the primary fluid circuit prior to being returned to the reservoir 26. Such control may be through controlling the operation of the two cooling cells 16 delivering the coolant to the polishing chamber 32. Under certain circumstances, it is foreseeable that operation of only one of the towers 12 and 14 may be required to achieve adequate cooling of the process fluid, such that the other tower 12 or 14 can be placed on “standby.” In such a case, the cooling cells 16 of the operational and standby towers 12 and 14 may be individually controlled to attain the desired final temperature of the processing fluid. For example, power to one or more of the cells 16 of the operational and standby towers may be throttled through a smoothed/conditioned PWM signal.

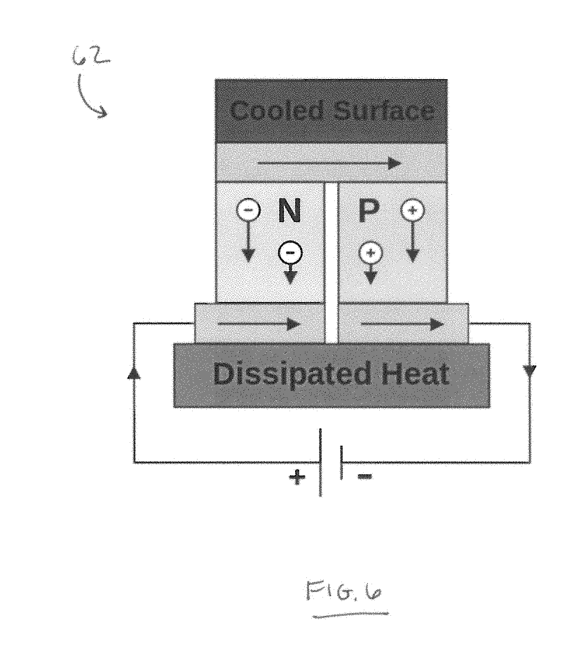

FIG. 5 schematically represents a more detailed view of one of the cooling cells 16, and FIG. 6 schematically represents one of two thermoelectric cooling devices 62 depicted as being used in the cell 16. In the nonlimiting example of FIG. 5, the cooling cell 16 comprises a water block 64 sandwiched between the cooling devices 62. Coolant is delivered to and drawn from the water block 64 through tubing 66 and 68, which connect the cooling cell 16 to either two of the fittings 48 and 50 of the primary tower 12 or two of the fittings 58 and 60 of the polishing tower 14. A “cold” side of each cooling device 62 extracts heat from one of two opposite sides of the water block 64, and heat pipes 70 conduct heat from the opposite “hot” side each device 62 to two corresponding heat sinks 72, each housing a fan 74 that dissipates heat from the heat sink 72.

Various types of thermoelectric cooling devices are known and commercially available for use as the cooling devices 62, a nonlimiting example of which is a thermoelectric cooler, model number TEC1-12706, commercially available from Hebei I. T. (Shanghai) Co., Ltd. This type of cooling device, schematically represented in FIG. 6, utilizes the Peltier Effect and a silicon chip. Current flows through a bimetal NPN/PNP silicon junction between two conductors, A and B, where heat may be generated or removed at the junction. The direction of heat flow is determined by polarity and creates a cold and hot side. Inducing current through two different conductors will cause heat to move from one conductor to the other, thus creating a temperature shift at the junction.

FIGS. 1, 3, and 4 represent multiple cooling cells 16 being used for each of the towers 12 and 14. Because thermoelectric cooling devices tend to cool faster and more efficiently when the medium to be cooled is above ambient, each tower 12 and 14 preferably utilizes multiple cells 16 to cool the same volume of process fluid or coolant.

From the foregoing description, it should be evident that the cooling cells 16 are used as the medium for transferring heat from the coolant (and, in turn, the process fluid), instead of a refrigerant. As a nonlimiting example it is expected that, with an outdoor ambient temperature of about 90° F., an initial process fluid temperature of about 80° F., and a desired process fluid temperature of about 50° F., a desirable temperature drop achieved with the cooling coils 20 (or other passive cooling unit) is about 10° F., a desirable temperature drop achieved with the primary tower 12 is about 15° F., and a desirable temperature drop achieved with the polishing tower 14 is about 5° F. In one investigation leading to the present invention, a system as described above and shown in the drawings was operated with water as the processing fluid in its primary fluid circuit and as the coolant in its secondary fluid circuit. The system was employed to cool a condensation surface of a distillation vessel of the type disclosed in U.S. patent application Ser. No. 15/603,822, and was capable of cooling the processing fluid to about 35° F. (about 1° C.). In another investigation, a system as described above and shown in the drawings was operated within an outdoor ambient temperature of about 100° F. and used to cool the condensation surface of a distillation vessel that was at a temperature of about 212° F. The system maintained thirty-two gallons of the processing fluid (water) within the reservoir 26 at a temperature of about 80° F., wherein the processing fluid was circulated at about 6 gallons/minute through the primary fluid circuit and the condensation surface.

While the invention has been described in terms of a particular embodiment, it should be apparent that alternatives could be adopted by one skilled in the art. For example, the system 10 and its components could differ in appearance and construction from the embodiment described herein and shown in the drawings, functions of certain components of the system 10 could be performed by components of different construction but capable of a similar (though not necessarily equivalent) function, process parameters (such as temperatures and flow rates) could be modified, and appropriate materials could be substituted for those noted. In addition, the invention encompasses additional or alternative embodiments in which one or more features or aspects of a particular embodiment could be eliminated. Accordingly, it should be understood that the invention is not necessarily limited to any embodiment described herein or illustrated in the drawings. It should also be understood that the phraseology and terminology employed above are for the purpose of describing the illustrated embodiment, and do not necessarily serve as limitations to the scope of the invention. Therefore, the scope of the invention is to be limited only by the following claims.

1. A system for cooling a process fluid, the system comprising:
a passive cooling means that receives the process fluid from a reservoir and cools the process fluid by thermal conduction to a heat sink;
an active cooling means that receives the process fluid from the passive cooling mean and cools the process fluid with a coolant cooled by at least one thermoelectric device; and
a housing that encloses the passive and active cooling means and serves as the heat sink for the passive cooling means.

2. The system according to claim 1, wherein the passive cooling means comprises at least one coil formed by winding a tubing through which the process fluid flows.

3. The system according to claim 1, wherein the active cooling means comprises:
a primary coil through which the process fluid flows after exiting the passive cooling means; and
a primary chamber that contains the coolant and in which the primary coil is immersed.

4. The system according to claim 3, wherein the active cooling means further comprises:
a second coil through which the process fluid flows after exiting the primary chamber; and
a second chamber that contains the coolant and in which the second coil is immersed.

5. The system according to claim 4, wherein the at least one thermoelectric device comprises:
a first plurality of thermoelectric devices that individually receive and cool the coolant from the primary chamber and return the cooled coolant to the primary chamber; and
a second plurality of thermoelectric devices that individually receive and cool the coolant from the second chamber and return the cooled coolant to the second chamber.

6. The system according to claim 1, wherein the at least one thermoelectric device comprises multiple thermoelectric devices that individually receive and cool the coolant.

7. The system according to claim 1, wherein the at least one thermoelectric device comprises a bimetal NPN/PNP silicon junction between two conductors.

8. The system according to claim 1, further comprising at least one cooling cell that comprises a first and second thermoelectric devices of the at least one thermoelectric device, the cooling cell comprising:
a water block sandwiched between the first and second thermoelectric devices, the coolant flowing through the water block;
first and second heat sinks; and
heat pipes contacting the first and second thermoelectric devices and conducting heat to the first and second heat sinks, respectively.

9. The system according to claim 1, wherein the reservoir is connected to and supplies the process fluid to a distillation vessel of a distillation system.

10. A process for cooling a process fluid, the process comprising:
passively cooling the process fluid by receiving the process fluid from a reservoir and cooling the process fluid by thermal conduction to a heat sink;
actively cooling the process fluid by receiving the process fluid after being passively cooled and cooling the process fluid with a coolant cooled by at least one thermoelectric device; and then
returning the process fluid to the reservoir.

11. The process according to claim 10, wherein the passive cooling is performed with at least one coil formed by a tube winding through which the process fluid flows.

12. The process according to claim 10, wherein the active cooling is performed by:
a primary coil through which the process fluid flows after being passively cooled; and
a primary chamber that contains the coolant and in which the primary coil is immersed.

13. The process according to claim 12, wherein the active cooling is further performed by:
a second coil through which the process fluid flows after exiting the primary chamber; and
a second chamber that contains the coolant and in which the second coil is immersed.

14. The process according to claim 13, wherein the at least one thermoelectric device comprises:
a first plurality of thermoelectric devices that individually receive and cool the coolant from the primary chamber and return the cooled coolant to the primary chamber; and
a second plurality of thermoelectric devices that individually receive and cool the coolant from the second chamber and return the cooled coolant to the second chamber.

15. The process according to claim 10, wherein the at least one thermoelectric device comprises multiple thermoelectric devices that individually receive and cool the coolant.

16. The process according to claim 10, wherein the at least one thermoelectric device comprises a bimetal NPN/PNP silicon junction between two conductors.

17. The process according to claim 10, wherein the coolant is cooled by:
flowing the coolant through a water block sandwiched between first and second thermoelectric devices; and
conducting heat from the first and second thermoelectric devices to first and second heat sinks, respectively.

18. The process according to claim 10, wherein the reservoir is connected to and supplies the process fluid to a distillation vessel of a distillation process.
